(19) United States
(12) Patent Application Publication
(10) Pub. No.: US 2025/0020455 A1
(43) Pub. Date: Jan. 16, 2025

(54) DEPTH SENSOR DEVICE AND METHOD FOR OPERATING A DEPTH SENSOR DEVICE

(71) Applicant: Sony Semiconductor Solutions Corporation, Atsugi-shi, Kanagawa (JP)

(72) Inventor: Marc OSSWALD, Stuttgart (DE)

(73) Assignee: Sony Semiconductor Solutions Corporation, Atsugi-shi, Kanagawa (JP)

(21) Appl. No.: 18/711,236

(22) PCT Filed: Dec. 5, 2022
(86) PCT No.: PCT/EP2022/084368

§ 371 Date: May 17, 2024

(30) Foreign Application Priority Data
Dec. 22, 2021 (JP) 21216960.1

(51) Int. Cl. G01B 11/25; G06T 7/521

(52) U.S. Cl. CPC G01B 11/2518; G01B 11/2513; G06T 7/521

(57) ABSTRACT

A depth sensor device for measuring a depth map of an object comprises a projector unit configured to illuminate different locations of the object during different time periods with an illumination pattern, a receiver unit comprising a plurality of pixels, the receiver unit being configured to detect on each pixel intensities of light reflected from the object while it is illuminated with the illumination pattern, and to generate an event at one of the pixels if the intensity detected at the pixel changes by more than a predetermined threshold, and a control unit configured to generate for each of the different time periods a total number of detected events and pixel information indicating for each event the pixel that detected the event, and to calculate from the pixel information and the total number a position of the image of the illumination pattern on the pixels with sub-pixel accuracy.

### FIELD OF THE INVENTION

The present disclosure relates to a depth sensor device and a method for operating a depth sensor device. In particular, the present disclosure is related to the generation of data for producing a depth map.

### BACKGROUND

In recent years techniques for automatic measuring of distances by sending and receiving light have drawn much attention to them. One such technique is the usage of structured light, i.e. the illumination of an object with static or time varying sparse light patterns such as line, bar or checkerboard patterns. For a known orientation of light source and camera it is possible to determine the shape and the distance of an object from triangulation based on the known positions of the light source, the camera, the orientation of the emitted light in space, and the position of the according light signal on the camera.

It is desirable to improve the resolution, the accuracy and the capture time of the depth maps obtained from triangulation.

### SUMMARY OF THE INVENTION

In conventional systems for depth estimation a set of illumination patterns providing high intensities at predetermined solid angles is sent out to an object and the distribution of light reflected from the object is measured by a receiver such as a camera. The task is then to find for the known solid angles of light emission, the solid angles of maximum light reception on the receiver. Due to the limited density of intensity changes in the illumination pattern and the limited pixel resolution, for the determination of the solid angle of maximum light reception a fit of the expected intensity distribution to the measured intensity values has to be made. In conventional systems this requires storage of all intensity values obtained at all pixels of the camera for all different illuminations. Only after all intensity values have been stored, a depth map can be generated. Thus, in conventional system memory space must be large. Further, complete storage of intensity values leads to an enhanced latency in the system. Also, the available pixel resolution is limited by the readout speed, if applications with real-time behavior are envisaged, since too many pixels will lead to too long processing times.

The present disclosure mitigates these shortcomings of conventional depth estimation techniques.

To this end, a depth sensor device for measuring a depth map of an object is provided which depth sensor device comprises a projector unit configured to illuminate different locations of the object during different time periods with an illumination pattern, a receiver unit comprising a plurality of pixels, the receiver unit being configured to detect on each pixel intensities of light reflected from the object while it is illuminated with the illumination pattern, and to generate an event at one of the pixels if the intensity detected at the pixel changes by more than a predetermined threshold, and a control unit configured to generate for each of the different time periods a total number of detected events and pixel information indicating for each event the pixel that detected the event, and to calculate from the pixel information and the total number a position of the image of the illumination pattern on the pixels with sub-pixel accuracy.

Further, a method for measuring a depth map of an object with the aforementioned depth sensor device is provided, the method comprising: illuminating with the projector unit different locations of the object during different time periods with an illumination pattern; detecting with the receiver unit on each pixel intensities of light reflected from the object while it is illuminated with the illumination pattern, and generating an event at one of the pixels if the intensity detected at the pixel changes by more than a predetermined threshold; generating with the control unit for each of the different time periods a total number of detected events and pixel information indicating for each event the pixel that detected the event; and calculating, with the control unit, from the pixel information and the total number a position of the image of the illumination pattern on the pixels with sub-pixel accuracy.

Instead of using intensity information of all pixels use is made of the properties of event vision sensors (EVS)/dynamic vision sensors (DVS) which only detect changes in intensities. Since the illumination patterns used for depth map generation are usually sparse, events will pile up only at pixel positions that receive the reflection of the illumination pattern from the object. Thus, a reduction of memory can already be achieved due to the reduction of pixels that produce an output to be stored.

Further, by referring to the distribution of events, i.e. by relying on information which pixels detected the events and on the total number of detected events, it is possible to calculate the position at which the reflection of the illumination pattern is received with sub-pixel accuracy, just as if full intensity information would have been used. Also, this manner of processing can save considerable memory space, since pixel addresses and event counts need comparably little memory space, if compared to intensity information. Moreover, readout of events can be performed faster, which allows in principle more pixels per area than available for a conventional system. This allows to further increase the resolution of the pixel array, which increases in turn the accuracy of the depth determination.

In this manner memory resources can be freed and latency through read-out times can be reduced. Further, the accuracy of depth determination can be increased.

### BRIEF DESCRIPTION OF THE DRAWINGS

FIG. 1A is a simplified block diagram of the event detection circuitry of a solid-state imaging device including a pixel array.

FIG. 1B is a simplified block diagram of the pixel array illustrated in FIG. 1A.

FIG. 1C is a simplified block diagram of the imaging signal read-out circuitry of the solid state imaging device of FIG. 1A.

FIG. 2 is shows schematically a depth sensor device.

FIG. 3 shows schematically a response characteristic of an event sensor in a depth sensor device.

FIG. 4 shows a schematic layout of a readout circuitry of a depth sensor device.

FIG. 5 shows a diagram for explaining how to achieve line detection with sub-pixel accuracy in a depth sensor device.

FIG. 6 shows a further diagram for explaining how to achieve line detection with sub-pixel accuracy in a depth sensor device.

FIG. 7 shows schematically a processor circuitry used in a depth sensor device.

FIG. 8 shows schematically another depth sensor device.

FIGS. 9A and 9B show further diagrams for explaining how to achieve line detection with sub-pixel accuracy in a depth sensor device.

FIGS. 10A and 10B show schematically different exemplary applications of a camera comprising a depth sensor device.

FIG. 11 shows schematically a head mounted display comprising a depth sensor device.

FIG. 12 shows schematically an industrial production device comprising a depth sensor device.

FIG. 13 shows a schematic process flow of a method of operating a depth sensor device.

FIG. 14 is a simplified perspective view of a solid-state imaging device with laminated structure according to an embodiment of the present disclosure.

FIG. 15 illustrates simplified diagrams of configuration examples of a multi-layer solid-state imaging device to which a technology according to the present disclosure may be applied.

FIG. 16 is a block diagram depicting an example of a schematic configuration of a vehicle control system.

FIG. 17 is a diagram of assistance in explaining an example of installation positions of an outside-vehicle information detecting section and an imaging section of the vehicle control system of FIG. 16.

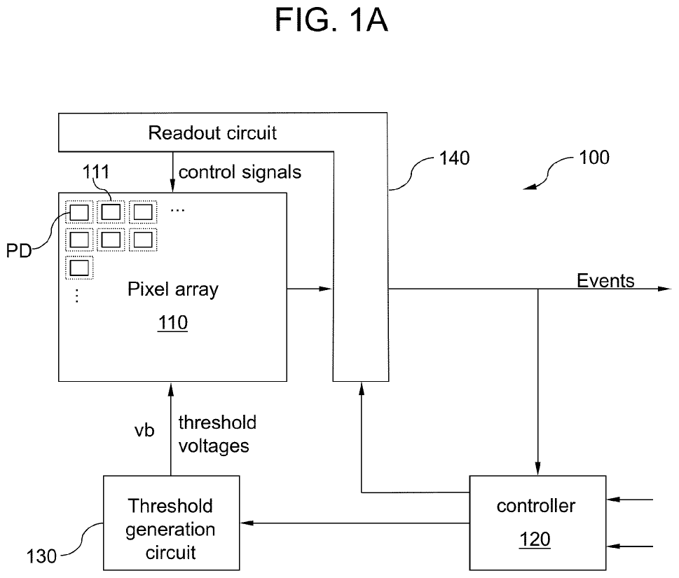

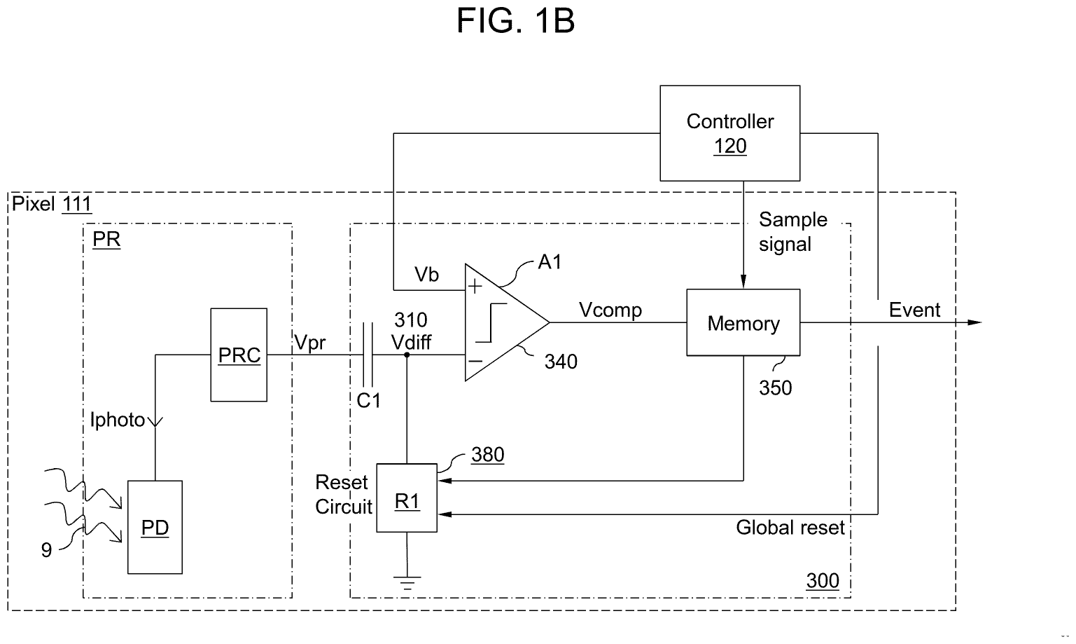

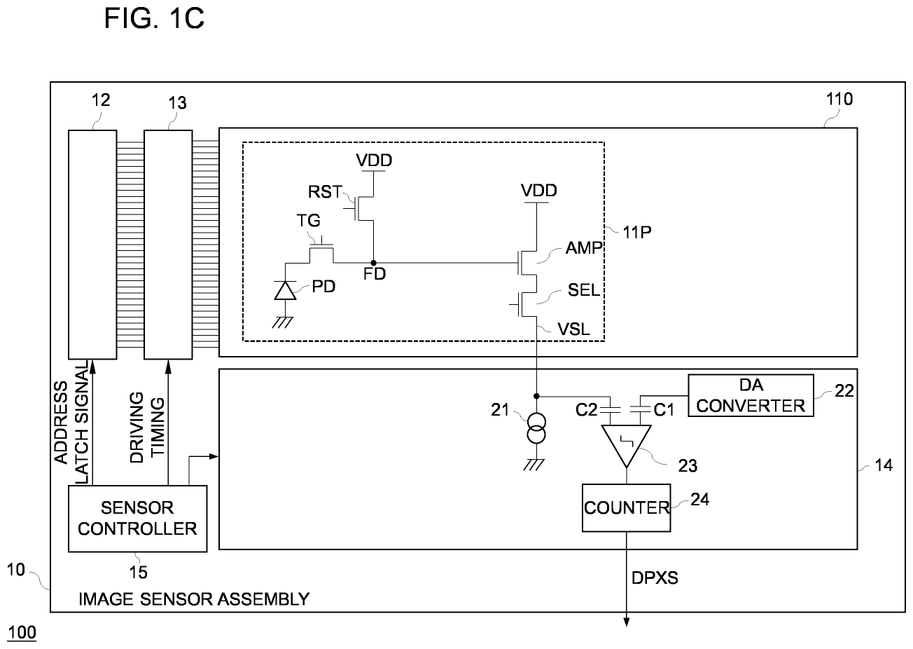

The present disclosure relies on event detection by event visions sensor/dynamic vision sensors. Although these sensors are in principle known to a skilled person a brief overview will be given with respect to FIGS. 1A to 1C.

FIG. 1A is a block diagram of a solid-state imaging device 100 employing event based change detection. The solid-state imaging device 100 includes a pixel array 110 with one or more imaging pixels 111, wherein each pixel 111 includes a photoelectric conversion element PD. The pixel array 110 may be a one-dimensional pixel array with the photoelectric conversion elements PD of all pixels arranged along a straight or meandering line (line sensor). In particular, the pixel array 110 may be a two-dimensional array, wherein the photoelectric conversion elements PDs of the pixels 111 may be arranged along straight or meandering rows and along straight or meandering lines.

The illustrated embodiment shows a two dimensional array of pixels 111, wherein the pixels 111 are arranged along straight rows and along straight columns running orthogonal the rows. Each pixel 111 converts incoming light into an imaging signal representing the incoming light intensity and an event signal indicating a change of the light intensity, e.g. an increase by at least an upper threshold amount and/or a decrease by at least a lower threshold amount. If necessary, the function of each pixel 111 regarding intensity and event detection may be divided and different pixels observing the same solid angle can implement the respective functions. These different pixels may be subpixels and can be implemented such that they share part of the circuitry. The different pixels may also be part of different image sensors. For the present disclosure, whenever it is referred to a pixel capable of generating an imaging signal and an event signal, this should be understood to include also a combination of pixels separately carrying out these functions as described above.

A controller 120 performs a flow control of the processes in the pixel array 110. For example, the controller 120 may control a threshold generation circuit 130 that determines and supplies thresholds to individual pixels 111 in the pixel array 110. A readout circuit 140 provides control signals for addressing individual pixels 111 and outputs information about the position of such pixels 111 that indicate an event. Since the solid-state imaging device 100 employs event-based change detection, the readout circuit 140 may output a variable amount of data per time unit.

FIG. 1B shows exemplarily details of the imaging pixels 111 in FIG. 1A as far as their event detection capabilities are concerned. Of course, any other implementation that allows detection of events can be employed. Each pixel 111 includes a photoreceptor module PR and is assigned to a pixel back-end 300, wherein each complete pixel back-end 300 may be assigned to one single photoreceptor module PR. Alternatively, a pixel back-end 300 or parts thereof may be assigned to two or more photoreceptor modules PR, wherein the shared portion of the pixel back-end 300 may be sequentially connected to the assigned photoreceptor modules PR in a multiplexed manner.

The photoreceptor module PR includes a photoelectric conversion element PD, e.g. a photodiode or another type of photosensor. The photoelectric conversion element PD converts impinging light 9 into a photocurrent Iphoto through the photoelectric conversion element PD, wherein the amount of the photocurrent Iphoto is a function of the light intensity of the impinging light 9.

A photoreceptor circuit PRC converts the photocurrent Iphoto into a photoreceptor signal Vpr. The voltage of the photoreceptor signal Vpr is a function of the photocurrent Iphoto.

A memory capacitor 310 stores electric charge and holds a memory voltage which amount depends on a past photoreceptor signal Vpr. In particular, the memory capacitor 310 receives the photoreceptor signal Vpr such that a first electrode of the memory capacitor 310 carries a charge that is responsive to the photoreceptor signal Vpr and thus the light received by the photoelectric conversion element PD. A second electrode of the memory capacitor C1 is connected to the comparator node (inverting input) of a comparator circuit 340. Thus the voltage of the comparator node, Vdiff varies with changes in the photoreceptor signal Vpr.

The comparator circuit 340 compares the difference between the current photoreceptor signal Vpr and the past photoreceptor signal to a threshold. The comparator circuit 340 can be in each pixel back-end 300, or shared between a subset (for example a column) of pixels. According to an example each pixel 111 includes a pixel back-end 300 including a comparator circuit 340, such that the comparator circuit 340 is integral to the imaging pixel 111 and each imaging pixel 111 has a dedicated comparator circuit 340.

A memory element 350 stores the comparator output in response to a sample signal from the controller 120. The memory element 350 may include a sampling circuit (for example a switch and a parasitic or explicit capacitor) and/or a digital memory circuit such as a latch or a flip-flop). In one embodiment, the memory element 350 may be a sampling circuit. The memory element 350 may be configured to store one, two or more binary bits.

An output signal of a reset circuit 380 may set the inverting input of the comparator circuit 340 to a predefined potential. The output signal of the reset circuit 380 may be controlled in response to the content of the memory element 350 and/or in response to a global reset signal received from the controller 120.

The solid-state imaging device 100 is operated as follows: A change in light intensity of incident radiation 9 translates into a change of the photoreceptor signal Vpr. At times designated by the controller 120, the comparator circuit 340 compares Vdiff at the inverting input (comparator node) to a threshold Vb applied on its non-inverting input. At the same time, the controller 120 operates the memory element 350 to store the comparator output signal Vcomp. The memory element 350 may be located in either the pixel circuit 111 or in the readout circuit 140 shown in FIG. 1A.

If the state of the stored comparator output signal indicates a change in light intensity AND the global reset signal GlobalReset (controlled by the controller 120) is active, the conditional reset circuit 380 outputs a reset output signal that resets Vdiff to a known level.

The memory element 350 may include information indicating a change of the light intensity detected by the pixel 111 by more than a threshold value.

The solid state imaging device 120 may output the addresses (where the address of a pixel 111 corresponds to its row and column number) of those pixels 111 where a light intensity change has been detected. A detected light intensity change at a given pixel is called an event. More specifically, the term ‘event’ means that the photoreceptor signal representing and being a function of light intensity of a pixel has changed by an amount greater than or equal to a threshold applied by the controller through the threshold generation circuit 130. To transmit an event, the address of the corresponding pixel 111 is transmitted along with data indicating whether the light intensity change was positive or negative. The data indicating whether the light intensity change was positive or negative may include one single bit.

To detect light intensity changes between current and previous instances in time, each pixel 111 stores a representation of the light intensity at the previous instance in time.

More concretely, each pixel 111 stores a voltage Vdiff representing the difference between the photoreceptor signal at the time of the last event registered at the concerned pixel 111 and the current photoreceptor signal at this pixel 111.

To detect events, Vdiff at the comparator node may be first compared to a first threshold to detect an increase in light intensity (ON-event), and the comparator output is sampled on a (explicit or parasitic) capacitor or stored in a flip-flop. Then Vdiff at the comparator node is compared to a second threshold to detect a decrease in light intensity (OFF-event) and the comparator output is sampled on a (explicit or parasitic) capacitor or stored in a flip-flop.

The global reset signal is sent to all pixels 111, and in each pixel 111 this global reset signal is logically ANDed with the sampled comparator outputs to reset only those pixels where an event has been detected. Then the sampled comparator output voltages are read out, and the corresponding pixel addresses sent to a data receiving device.

FIG. 1C illustrates a configuration example of the solid-state imaging device 100 including an image sensor assembly 10 that is used for readout of intensity imaging signals in form of an active pixel sensor, APS. Here, FIG. 1C is purely exemplary. Readout of imaging signals can also be implemented in any other known manner. As stated above, the image sensor assembly 10 may use the same pixels 111 or may supplement these pixels 111 with additional pixels observing the respective same solid angles. In the following description the exemplary case of usage of the same pixel array 110 is chosen.

The image sensor assembly 10 includes the pixel array 110, an address decoder 12, a pixel timing driving unit 13, an ADC (analog-to-digital converter) 14, and a sensor controller 15.

The pixel array 110 includes a plurality of pixel circuits 11P arranged matrix-like in rows and columns. Each pixel circuit 11P includes a photosensitive element and FETs (field effect transistors) for controlling the signal output by the photosensitive element.

The address decoder 12 and the pixel timing driving unit 13 control driving of each pixel circuit 11P disposed in the pixel array 110. That is, the address decoder 12 supplies a control signal for designating the pixel circuit 11P to be driven or the like to the pixel timing driving unit 13 according to an address, a latch signal, and the like supplied from the sensor controller 15. The pixel timing driving unit 13 drives the FETs of the pixel circuit 11P according to driving timing signals supplied from the sensor controller 15 and the control signal supplied from the address decoder 12. The electric signals of the pixel circuits 11P (pixel output signals, imaging signals) are supplied through vertical signal lines VSL to ADCs 14, wherein each ADC 14 is connected to one of the vertical signal lines VSL, and wherein each vertical signal line VSL is connected to all pixel circuits 11P of one column of the pixel array unit 11. Each ADC 14 performs an analog-to-digital conversion on the pixel output signals successively output from the column of the pixel array unit 11 and outputs the digital pixel data DPXS to a signal processing unit. To this purpose, each ADC 14 includes a comparator 23, a digital-to-analog converter (DAC) 22 and a counter 24.

The sensor controller 15 controls the image sensor assembly 10. That is, for example, the sensor controller 15 supplies the address and the latch signal to the address decoder 12, and supplies the driving timing signal to the pixel timing driving unit 13. In addition, the sensor controller 15 may supply a control signal for controlling the ADC 14.

The pixel circuit 11P includes the photoelectric conversion element PD as the photosensitive element. The photoelectric conversion element PD may include or may be composed of, for example, a photodiode. With respect to one photoelectric conversion element PD, the pixel circuit 11P may have four FETs serving as active elements, i.e., a transfer transistor TG, a reset transistor RST, an amplification transistor AMP, and a selection transistor SEL.

The photoelectric conversion element PD photoelectrically converts incident light into electric charges (here, electrons). The amount of electric charge generated in the photoelectric conversion element PD corresponds to the amount of the incident light.

The transfer transistor TG is connected between the photoelectric conversion element PD and a floating diffusion region FD. The transfer transistor TG serves as a transfer element for transferring charge from the photoelectric conversion element PD to the floating diffusion region FD. The floating diffusion region FD serves as temporary local charge storage. A transfer signal serving as a control signal is supplied to the gate (transfer gate) of the transfer transistor TG through a transfer control line.

Thus, the transfer transistor TG may transfer electrons photoelectrically converted by the photoelectric conversion element PD to the floating diffusion FD.

The reset transistor RST is connected between the floating diffusion FD and a power supply line to which a positive supply voltage VDD is supplied. A reset signal serving as a control signal is supplied to the gate of the reset transistor RST through a reset control line.

Thus, the reset transistor RST serving as a reset element resets a potential of the floating diffusion FD to that of the power supply line.

The floating diffusion FD is connected to the gate of the amplification transistor AMP serving as an amplification element. That is, the floating diffusion FD functions as the input node of the amplification transistor AMP serving as an amplification element.

The amplification transistor AMP and the selection transistor SEL are connected in series between the power supply line VDD and a vertical signal line VSL.

Thus, the amplification transistor AMP is connected to the signal line VSL through the selection transistor SEL and constitutes a source-follower circuit with a constant current source 21 illustrated as part of the ADC 14.

Then, a selection signal serving as a control signal corresponding to an address signal is supplied to the gate of the selection transistor SEL through a selection control line, and the selection transistor SEL is turned on.

When the selection transistor SEL is turned on, the amplification transistor AMP amplifies the potential of the floating diffusion FD and outputs a voltage corresponding to the potential of the floating diffusion FD to the signal line VSL. The signal line VSL transfers the pixel output signal from the pixel circuit 11P to the ADC 14.

Since the respective gates of the transfer transistor TG, the reset transistor RST, and the selection transistor SEL are, for example, connected in units of rows, these operations are simultaneously performed for each of the pixel circuits 11P of one row. Further, it is also possible to selectively read out single pixels or pixel groups.

The ADC 14 may include a DAC 22, the constant current source 21 connected to the vertical signal line VSL, a comparator 23, and a counter 24.

The vertical signal line VSL, the constant current source 21 and the amplifier transistor AMP of the pixel circuit 11P combine to a source follower circuit.

The DAC 22 generates and outputs a reference signal. By performing digital-to-analog conversion of a digital signal increased in regular intervals, e.g. by one, the DAC 22 may generate a reference signal including a reference voltage ramp. Within the voltage ramp, the reference signal steadily increases per time unit. The increase may be linear or not linear.

The comparator 23 has two input terminals. The reference signal output from the DAC 22 is supplied to a first input terminal of the comparator 23 through a first capacitor C1. The pixel output signal transmitted through the vertical signal line VSL is supplied to the second input terminal of the comparator 23 through a second capacitor C2.

The comparator 23 compares the pixel output signal and the reference signal that are supplied to the two input terminals with each other, and outputs a comparator output signal representing the comparison result. That is, the comparator 23 outputs the comparator output signal representing the magnitude relationship between the pixel output signal and the reference signal. For example, the comparator output signal may have high level when the pixel output signal is higher than the reference signal and may have low level otherwise, or vice versa. The comparator output signal VCO is supplied to the counter 24.

The counter 24 counts a count value in synchronization with a predetermined clock. That is, the counter 24 starts the count of the count value from the start of a P phase or a D phase when the DAC 22 starts to decrease the reference signal, and counts the count value until the magnitude relationship between the pixel output signal and the reference signal changes and the comparator output signal is inverted. When the comparator output signal is inverted, the counter 24 stops the count of the count value and outputs the count value at that time as the AD conversion result (digital pixel data DPXS) of the pixel output signal.

An according event sensor might be used in the following, when it is referred to event detection. However, any other manner of implementation of event detection might be applicable. In particular, event detection may also be carried out in sensors directed to external influences other than light, like e.g. sound, pressure, temperature or the like. In principle, the below description could be applied to any sensor that provides a binary output in response to the detection of intensities.

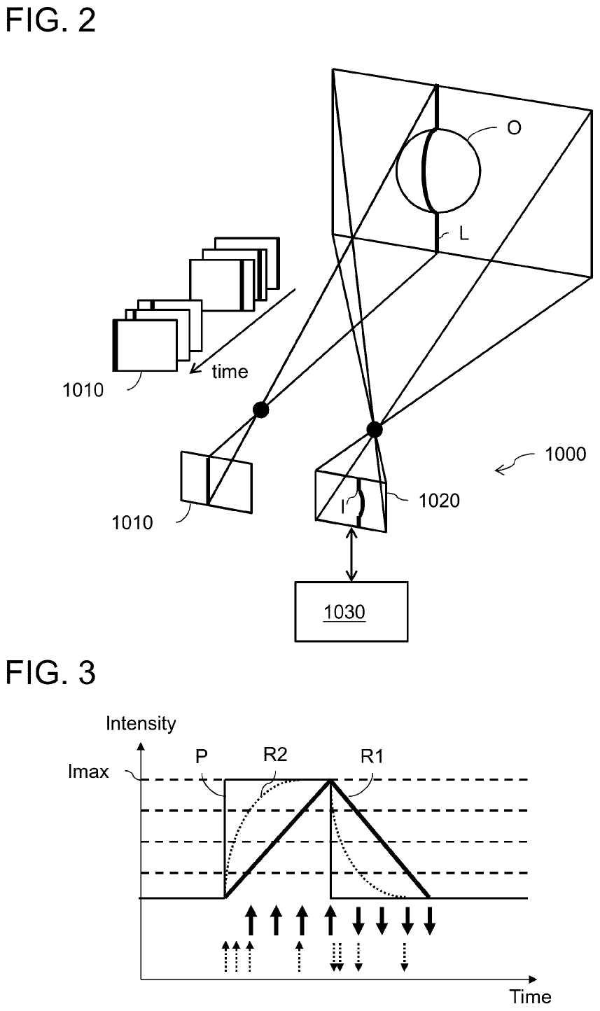

FIG. 2 shows schematically a depth sensor device 1000 for measuring a depth map of an object O, i.e. a device that allows deduction of distances of surface elements of the object O to the depth sensor device 1000. The depth sensor device 1000 may be capable to generate the depth map itself or may only generate data based on which the depth map can be established in further processing steps.

The depth sensor device 1000 comprises a projector unit 1010 configured to illuminate different locations of the object O during different time periods with an illumination pattern. In the exemplary illustration of FIG. 2 the illumination pattern is a line L projected onto the object O, where a position of the line L changes with time such that during different time periods different parts of the object O are illuminated with the line L. Although the below description focuses on this line example, a skilled person readily understands that also other sparse illumination patterns may be used.

The change of the illumination may be effected e.g. by using a fixed light source, the light of which is deflected at different times at different angles. For example, a mirror tilted by a micro-electro-mechanical system (MEMS) might be used to deflect the illumination pattern. Alternatively, an array of vertical-cavity surface-emitting lasers (VCSELs) or any other laser LEDs might be used that illuminate different parts of the object O at different times. Further, it might also be possible to use shielding optics like slit plates or LCD-panels to produce time varying illumination patterns.

Alternatively, the illumination pattern sent out from the projector unit 1010 may be fixed, while the object O moves across the illumination pattern. In principle, the precise manner of the generation of the illumination pattern and its movement across the objection is arbitrary, as long as different positions of the object O are illuminated during different time periods.

The depth sensor device 1000 comprises a receiver unit 1020 comprising a plurality of pixels 1025. Due to the surface structure of the object O, the illumination pattern is reflected from the object O in distorted form and forms an image I of the illumination pattern on the receiver unit 1020. The pixels 1025 of the receiver unit 1020 may in principle be capable to generate a full intensity image of the received reflection. More importantly, the receiver unit 1020 is configured to detect on each pixel 1025 intensities of light reflected from the object O while it is illuminated with the illumination pattern, and to generate an event at one of the pixels 1025 if the intensity detected at the pixel 1025 changes by more than a predetermined threshold. Thus, the receiver unit 1020 can act as an event sensor as described above with respect to FIGS. 1A to 1C that can detect changes in the received intensity that exceed a given threshold. Here, positive and negative changes might be detectable, leading to events of so-called positive or negative polarity. Further, the event detection thresholds might be dynamically adaptable and might differ for positive and negative polarities.

The depth sensor device 1000 further comprises a control unit 1030 that is configured to generate for each of the different time periods a total number of detected events and pixel information indicating for each event the pixel 1025 that detected the event, and to calculate from the pixel information and the total number a position of the image I of the illumination pattern on the pixels 1025 with sub-pixel accuracy. During each of the different time periods different images of the illumination pattern on the object O are received at the receiver unit. This will lead to a series of positive polarity events at new pixel positions of the image I and to a series of negative polarity events at the former pixel position of the image I. For each image obtained during a time period of static illumination pattern the control unit 1030 counts the detected events and retrieves, for each event, information indicating the event generating pixel 1025. This allows deducing on which pixels 1025 the image I was projected, since pixels 1025 receiving the most intensity will produce the most events. By using common interpolation techniques the position of the image can be achieved with sub-pixel precision.

In this manner it is possible to generate information that allows calculation of a depth map of an imaged scene with low latency and high accuracy.

For this process it might be beneficial if each pixel 1025 has a response characteristic according to which an instantaneous change of the received intensity to be detected to a given intensity value leads to a gradual change of the detected intensity over time until the detected intensity amounts to the given intensity value. In fact, this gradual change of the detected intensity allows detecting events on a single pixel with a time resolution for which each transgression of the event threshold produces an event.

This will be explained with respect to the exemplary and schematic diagram of FIG. 3. The graph P of FIG. 3 shows an idealized intensity signal on a given pixel 1025 that is obtained when the pixel 1025 receives a part of the image I of the illumination pattern. The intensity rises almost instantaneously to the given intensity value Imax, i.e. the maximal intensity value of the signal. After a predetermined time period, the illumination pattern on the object O changes, which leads to an almost instantaneous drop of the received intensity.

FIG. 3 shows two different exemplary response signals. The response signal R1 shows a strong time delay, which leads to an almost linear increase of the detected intensity, i.e. the intensity signal that is registered by the pixel 1025. The response signal R2 shows an exponential response, i.e. a fast initial rise/fall that becomes gradually slower until the signal reaches saturation.

FIG. 3 shows additionally horizontal dashed lines that indicate intensity levels corresponding to a multiple of the event threshold. Thus, each time one of the response signals R1, R2 crosses one of the dashed lines, an event is generated, as indicated by the arrows below the response signals R1, R2. For rising signals positive polarity events will be generated (arrows up), while for falling signals negative polarity events will be generated (arrows down).

By using according response characteristics, i.e. by using an EVS with a logarithmic or linear front-end, it is ensured that the number of events that is detected by a single pixel 1025 is a measure of the maximal intensity Imax seen by this pixel 1025. This means that by simply counting events an estimation on the received intensity can be obtained without the necessity to capture, store, and process the full intensity signal. Thus, the fast event processing can be used to generate precise depth maps (or information allowing generating those precise depth maps).

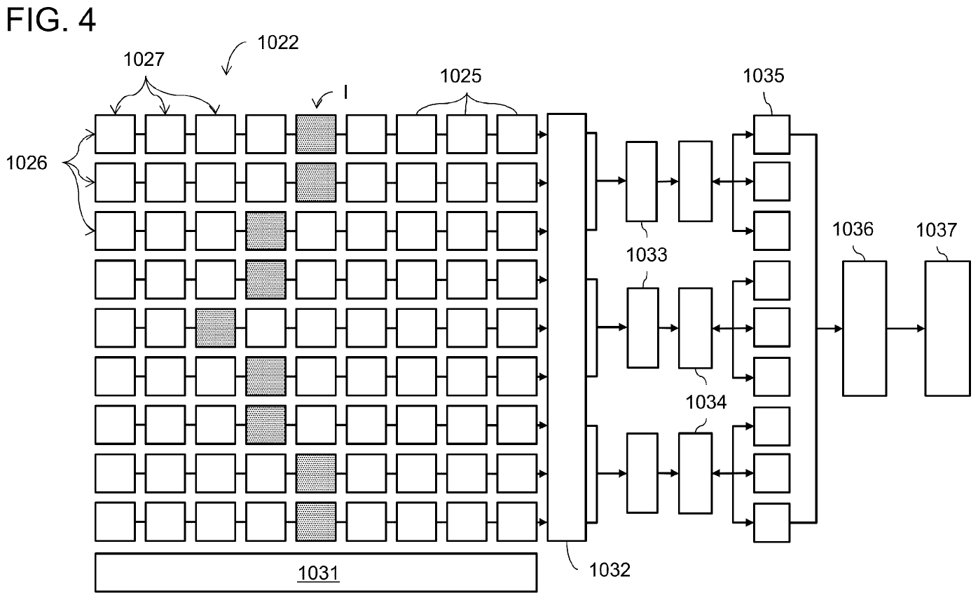

FIG. 4 shows schematically an exemplary block diagram of the components of the receiver unit 1020 and the control unit 1030. In this example, the projector unit 1010 is configured to illuminate the object O with a line L as shown in FIG. 2. The plurality of pixels 1025 of the receiver unit 1020 are arranged in a two-dimensional array 1022 that is ordered in rows 1026 and columns 1027, where a row number and a column number is assigned to each pixel 1025. The control unit 1030 is configured to treat the pixel information for each row 1026 separately and for each row 1026 the pixel information indicates the column numbers of the pixels 1025 in the row 1026. Further, the control unit 1030 is configured to calculate for each row 1026 a weighted sum of the column numbers of the pixels 1025 that detected events, and to calculate the position of the image I of the line L on the respective row 1026 by dividing this sum by the total numbers of events detected in the respective row 1026.

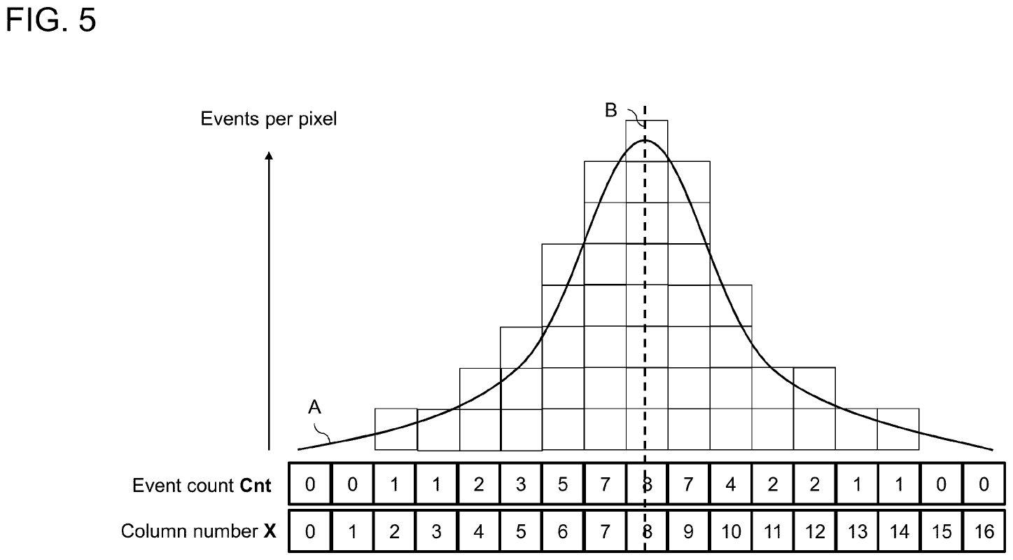

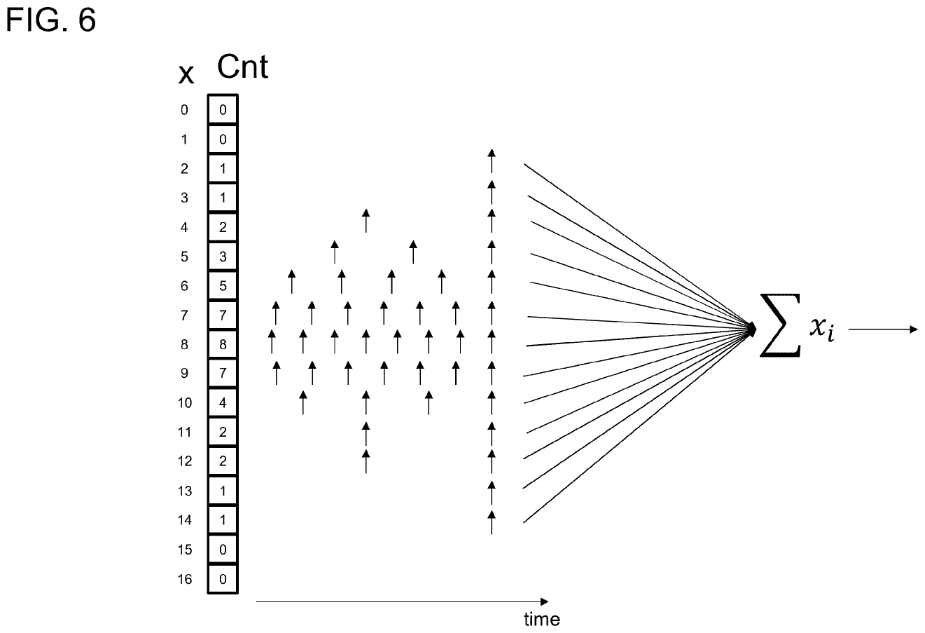

The position of the image I of the line L is shown in FIG. 4 by the shaded pixels 1025. Around these shaded pixels 1025 most of the events will pile up. The control unit 1030 is capable to determine for each of the rows 1026 the position of the image I by counting how many events were detected by which of the pixels 1025 of the respective row 1026. In particular, the control unit 1030 sums the column numbers of all these pixels 1025 (if necessary in a weighted manner) and divides the sum by the total number of events detected in the row 1026. This will give the position of the image I with sub-pixel accuracy as will be explained with respect to FIGS. 5 and 6.

FIG. 5 shows exemplarily the number of events obtained due to reception of line image I in a single row 1026. As illustrated by graph A, the image I may lead to an approximately Gaussian intensity distribution around a center position B of the image I of the line L, e.g. due to generating line L with a laser having a Gaussian shaped width profile. The Gaussian distribution of intensities leads to different numbers of events in the pixels 1025 of row 1026 as indicated by the event count Cnt.

The center position B equals the weighted mean of pixel coordinates/column numbers xᵢ

$$\overline{x} = \frac{1}{C} {\sum }_{i = 0}^{16} {c}_{i} {x}_{i} = 7.89 ,$$

with the weights cᵢ being equal to the event count at the pixel with column number xᵢ, and C indicating the total number of event in the row 1026.

Although this expression can of course be calculated at the end of the time period leading to the projection of the image I on the pixel row 1026, this makes storage of all event counts for all pixels 1025 necessary. Since this has to be done for each row 1026 in order to obtain a depth map, a large amount of memory would be needed in this approach. The control unit 1030 may therefore also be able to calculate the above expression on the fly by using the above described method, i.e. by adding up the column numbers of the pixels 1025 that detected events as soon as the events are detected, and only counting the total number of events.

The reason why this is possible is that the product cᵢ·xᵢ is mathematically equivalent to the sum of xᵢ+ . . . +xᵢ with the number of summands being cᵢ. Thus, instead of calculating the above expression by multiplying, it can just as well be obtained by summing. Moreover, this sum also does not need to be ordered, i.e. events leading to the same column number in the sum do not need to be obtained consecutively as long as all column numbers belonging to all events are summed.

This is visualized in FIG. 6 which shows the same event count as FIG. 5, but also adds the time resolution of the event detection by showing arrows at the corresponding pixel positions for each detected event. The series of detected events may therefore be processed on the fly by simply adding up the corresponding column numbers when an event is detected in the respective pixel 1025. In the example of FIG. 6 this would lead to a sum S of column numbers that starts as

$$S = 8 + 7 + 9 + 6 + 8 + 10 + 7 + 9 + …$$

At the same time, whenever a summand is added to the sum S the total event number counter C is increased by one. At the end, the weighted mean indicating the center position B of the image I is obtained by dividing S by C, i.e.

$$\overline{x} = \frac{s}{c} .$$

Thus, the center position B can be obtained with sub-pixel accuracy by basically storing only two different values for each row: the current value of the sum S and the current value C of the total number of events detected in the row 1026. Thus, in comparison to storage of the full intensity information or even the pixel addresses of all pixels which have detected events, the necessary storage capacity can be reduced a lot. In addition, the summing and counting operations, and even the division, can be performed fast by hardware components. This reduces the latency of the system and allows for a high time resolution of the depth measurement.

The above example assumed a Gaussian-shaped laser line for simplicity. Here, the sum of column numbers can be formed with weights of each column number equal to one. For a non-Gaussian-shaped laser line the center position can be obtained as well, if weights different from one are multiplied with the column numbers.

The above can be effected e.g. in that for each of the different time periods of varying illumination the control unit 1030 is configured to consecutively scan all columns 1027 in the pixel array 1022 a plurality of times, to detect during a scan of one column 1027 all pixels 1025 in the column 1027 that detected an event since the last scan, to add the column number of those pixels 1025 to the sum of column numbers for each row 1026 of said column 1027 containing one of those pixels 1025, and to increase a counter for the total number of events by one for each detected event. Here, the sum of column numbers is for each row formed from the column numbers obtained during the plurality of times of scanning and the counter counts each event detected during the plurality of times of scanning until a next one of the different time periods starts, and the control unit 1030 is configured to calculate the position of the image I of the line L from the sum of column numbers and the counted total number of events obtained until the next one of the different time periods starts.

In this manner all rows can be read out in parallel a plurality of times in order to detect all events that were generated since the last change of the illumination of the object O.

This process may be implemented by using the circuitry illustrated in FIG. 4. Here, the control unit 1030 comprises a row scanner unit 1031 that checks consecutively whether or not events have been detected in the columns 1027 of the pixel array 1022 and scans in this manner all the rows 1026 in parallel. The scanning process may start with the first pixel 1025 in each row 1026 (first column 1027), continues with the second pixel 1025 in each row 1026 (second column 1027), and so on until the last pixel 1025/last column 1027 is reached. Then, the process starts anew at the first column 1027 and continues in this manner until the illumination of the object O changes. It should be noted here that the scanning clock cycle can be much higher than the clock cycle of the projector unit 1010 for changing the illumination. In particular, the scanning clock cycle may be 5, 10, 20, 30 or 50 times higher than the clock cycle of the projector unit 1010.

The results of event detection are buffered for one column readout cycle in column buffer unit 1032. For example, a binary “1” might be stored for a detected event, while “0” is stored for no detection. Also by using two bits on and off events may be separately indicated. For a consecutive readout of the columns 1027 it is known (e.g. by counting) which column 1027 is actually scanned. In this case, the column number does not need to be stored explicitly. However, the columns 1027 may also be readout without particular order. Then, the buffer may also store the respective column number.

Event generator unit 1033 receives the event indication of the pixels of one column from the column buffer, and translates detected events into column numbers. For example, each “1” may be replaced by the column number (known from the ordered readout or from the column buffer), while each “0” terminates the processing for the corresponding pixel 1025.

Any column number obtained in the event generator unit 1033 is forwarded to event processing unit 1034, where it is added to the previously accumulated amount of the sum S, to update this amount. At the same time the event processing unit 1034 increases the total event number C by one. The intermediate values of S and C may be stored within the processing unit 1034 (e.g. in a register) or outside the processing unit 1034. In this case, the processing unit 1034 retrieves the intermediate values, updates them, and outputs the updated values for storage. In this manner the event processing unit 1034 obtains the two quantities S and C by simple summing operations. After the illumination of the object O has changed, which might be signaled to the control unit 1030 (or the event processing unit 1034) by the projector unit 1010, the event processing unit 1034 may form the ratio S/C to obtain the position of the image of the illumination pattern with sub-pixel accuracy for the respective row 1026. It is apparent that this position can be obtained in the above described manner in a particularly easy and fast manner.

In FIG. 4 the event generation unit 1033 and the event processing unit 1034 are illustrated to be shared between three rows 1026. However, every row 1026 may have its own event generation unit 1033 and event processing unit 1034, which makes processing faster. Just the same, also more than three rows 1026 may share one event generation unit 1033 and one event processing unit 1034, which leads to a simpler circuit, but will not be so fast.

As illustrated in FIG. 4 the control unit 1030 may comprise a memory unit 1035 that is configured to store consecutively for each of the different time periods the position of the image I of the line L in each row 1026. Here, the control unit 1030 is configured to output consecutively for each of the different time periods a column vector containing the position of the image I of the line in each row 1026 with sub-pixel accuracy. The memory unit 1035 may also store the S and C values in case there is no memory or register in the processing unit 1034. Furthermore, the memory unit 1035 might also be configured to store all events just as a common event based sensor. Optionally, the memory unit 1035 might be part of the processing unit 1034.

Thus, the depth sensor device 1000 may output readily usable position information regarding the result of the reflection of the illumination pattern from the object O. This information may be combined in formatting unit 1036 with the vectors obtained for all different illuminations, i.e. of all different lines in the line example of FIG. 2. Then, an output interface 1037 of the depth sensor device 1000 outputs a matrix of image positions within all rows for all different illuminations. This information is equivalent to the information obtainable by a full intensity analysis. However, it is obtained with much less memory in much less time. Further, if the number of EVS-pixels is increased in comparison to a conventional image sensor, then also the accuracy of the image position determination increases.

Here, the depth sensor device 1000 may comprise a depth map calculation unit that is configured to calculate from the column vectors obtained for each of the different time periods, i.e. for all different illuminations of the object O, a depth map of the object O. This is done in the commonly known manner. The depth sensor device provides then a full depth map as output.

Just the same, the depth sensor device 1000 may not carry out the division of S by C, since a division is a relatively expensive function in a hardware implementation. The depth sensor device may then output the S and C values for each row and each illumination of the object O instead of the image position. These data can then be used by according software to generate the depth map in a following processing step.

In particular, the control unit 1030 may comprise hardware components that are configured to generate the total number of detected events and the pixel information and software components that are configured to calculate the position of the image I of the illumination pattern. This has the advantage that e.g. the relatively simple summing operations can be implemented in hardware very fast, while division operations, concatenation of column vectors, or event map generation can be executed in a more efficient manner by software.

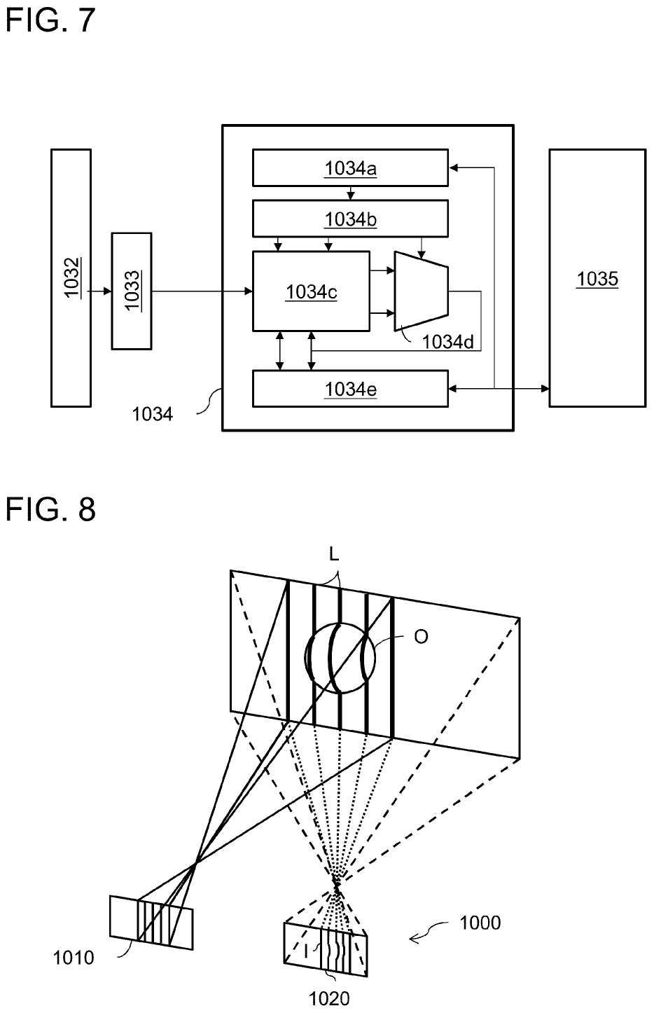

An example for such a structure is illustrated in FIG. 7 that shows components of a simple processor constituting the event processing unit 1034. The event processing unit 1034 may according to this example operate based on a program 1034a that provides via an instruction decoder 1034b instructions to registers 1034c and an arithmetic logic unit 1034d that does the necessary calculations. The outcome of these is provided to memory interface 1034e that is configured to communicate with memory 1035. The event processing unit 1034 may, however, also be implemented in an even simpler fashion, e.g. as simple multiply-accumulate unit. On the other hand, also more components as e.g. a floating-point unit may be included.

The control unit 1030 or parts thereof may therefore be implemented as hardware as far as fast computations are considered necessary. It might also include software components, if functional diversity is demanded or if functions would be too resource expensive when implemented in hardware.

An example for such functions might be the truncation of noise events, i.e. an outlier rejection that removes events from pixels far from the actual image of the illumination pattern from the result of the image position determination. To this end, the event processing unit 1034 might have the capability to calculate the weighted mean

$$\overline{x} = \frac{1}{C} {\sum }_{i = 0}^{n} {c}_{i} {x}_{i}$$

from time to time by referring to event counts cᵢ stored additionally for column number xᵢ. This mean can then be used to reject outliers, e.g. by ignoring 10% of the largest and smallest values or by removing events generated at pixels that are more than 2 or 3 standard deviations or mean absolute deviations away from the weighted mean. However, since this manner of outlier rejection requires storage of event counts cᵢ for all pixels, it is preferably only used for error estimation in order to keep the latency of the system low. In this process, one might also try to make use of different information obtainable by on and off events, e.g. by comparing estimated positions of the image obtained from positive and negative events.

Without such storage of event counts cᵢ outlier rejection might be obtained if the control unit 1030 is configured to calculate for each row 1026 an intermediate sum of the column numbers of the first k pixels 1025 that detected events, and to calculate an approximated position of the image I of the line L on the respective row 1026 by dividing this intermediate sum by k, where k is a predetermined natural number. The control unit 1030 is then configured to reject events of pixels 1025 in each of the rows 1026 that are located more than an outlier rejection threshold away from the approximated position calculated for the respective row 1026.

Thus, the first events detected in each row are used to set an expected range for further events to occur. Any events not lying in this range are rejected. The outlier rejection threshold might amount to 10, 20, 50 or 100 pixels or 10% of the row size. The number k may amount to 5, 10, or 20. The outlier rejection threshold might be adjusted during the processing depending on the events detected after the first k detected events.

The control unit 1030 may also be configured to adjust the approximated position of the image of the illumination pattern.

An according approach calculates the mean and deviation on the fly by moving the current value a small step into the direction of the next input. Outliers can be rejected on the fly by setting a threshold based on the standard deviation. This approach can be initialized by setting up multiple hypotheses (e.g. 2 to 3) randomly (e.g. at the positions of the first inputs) and then takes the one producing the least rejections. If one hypothesis does generate too many rejections, e.g. three successive rejections, it could be deleted. Instead, a new one could be initialized. The shift of the mean and the standard deviation with time steps t might be influenced by a parameter c as shown below:

$$\overline{{x}_{t}} = α {\overline{x}}_{t - 1} + ( 1 - α ) {x}_{t} ,$$

$${σ}_{t} = α {σ}_{t - 1} + ( 1 - α ) {( {σ}_{t - 1} - {x}_{t} )}^{2} .$$

The above approaches of outlier rejection might also be refined by treating positive polarity and negative polarity events separately or by taking knowledge about the projected illumination pattern into account. For example, the mean generated for positive polarity events could be used to define outlier rejection for negative polarity evets. The final image position may then be calculated only based on the negative polarity events.

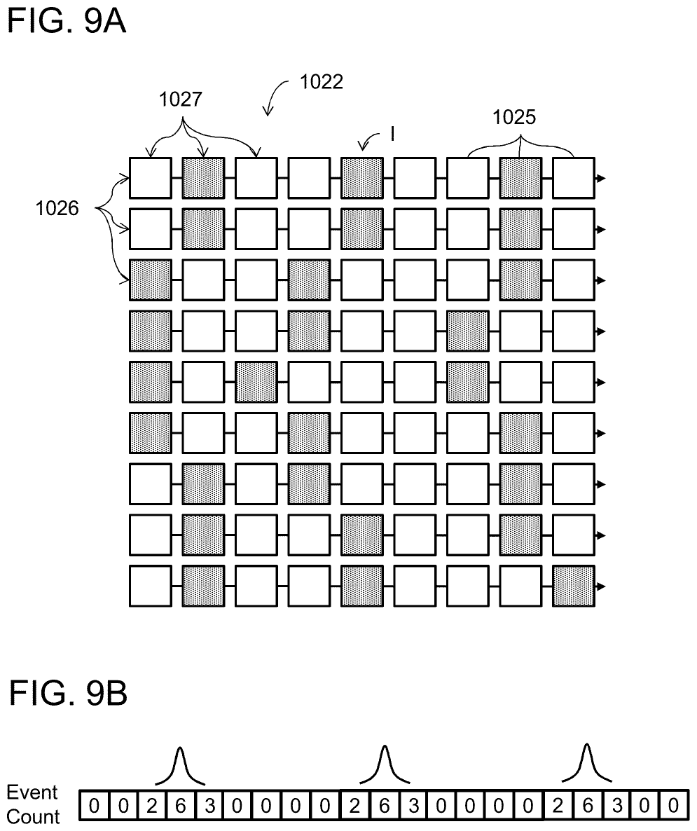

The above explanation has exemplarily focused on a single line L as the illumination pattern. However, also more sophisticated illumination patterns might be used. As an example for such patterns usage of a multiple line pattern will be discussed with respect to FIGS. 8, 9A and 9B.

As illustrated in FIG. 8 the projector unit 1010 is configured to illuminate the object O with multiple lines L. Also in this case the plurality of pixels 1025 may be arranged in a two-dimensional array 1022 ordered in rows 1026 and columns 1027 that assign to each pixel 1025 a row number and a column number. The control unit 1030 is configured to treat the pixel information for each row 1026 separately, and for each row 1206 the pixel information indicates the column numbers of the pixels 1025 in the row 1026, as in the example using a single line L. Further, the control unit 1030 is configured to calculate for each row 1026 a plurality of sums of the column numbers of the pixels 1025 that detected events, where the number of sums equals the number of projected lines L, and to calculate the positions of the images I of the lines L on the respective row 1026 by dividing these sums by the numbers of events detected in the respective row 1026 that were assigned to the respective sum. Thus, instead of summing all column numbers of all the event detecting pixels 1025 of a row 1026, events are grouped according to the position of the generating pixels 1025 in the row 1026.

It can be seen e.g. in FIGS. 9A and 9B for an example of a three line pattern that the positions of intensity maxima of the various lines are sufficiently separated to allow separation of pixels 1025 that generate events due to the different images I of the lines L on the pixel array 1022. Then, by only adding the column numbers of pixels 1025 affected by one of the lines, and by using the number of events detected by these pixels 1025 instead of the total event count for the entire row 1026, the positions of the images of each of the three lines can be deduced just in the manner used for the single line case. The processing circuitry shown in FIG. 4 can therefore also be used in this example, however, with the adaption that as many event counts and as many column number sums need to be stored as there are lines that are projected by the projector unit 1010 at the same time.

How to separate events generated by different lines is in principle arbitrary. Exemplary, one might assign a column number xᵢ to a given column number sum Sⱼ that summed already Cⱼ events under the following update rule:

$${S}_{j}^{( t )} = \{ \begin{matrix}{S}_{j}^{( t - 1 )} + {x}_{i} & if {x}_{i} - \frac{{S}_{j}^{( t )}}{{C}_{j}^{( t )}} \leq σ \\ {S}_{j}^{( t - 1 )} & else\end{matrix}$$

where σ is an appropriately set threshold that might e.g. depend on the number of lines in the pattern. If a column number xᵢ cannot be assigned to any Sⱼ and there exists one Sⱼ that is generated by none or only one event, this Sⱼ may be replaced with the new xᵢ. Such a (re)initialization condition may be used for initialization and makes it less likely that a sum gets stuck at a noise event and is not updated. It might also be preferable that the memory holds a number of states j that is larger than the number of lines n. Then the best results can be chosen in a postprocessing step, e.g. by choosing the n Sⱼ having the highest event count Cⱼ.

The output of the depth sensor device 1000 may in this case be equal to a number of column vectors equal to the number of lines, each vector containing the image positions of one of the lines in each row with sub-pixel accuracy. In scanning the plurality of lines across the object, a multiple of such vectors can be obtained that allow to generate a depth map. As described above for the single line case, it might also be possible to output the sums Sⱼ and the counts Cⱼ belonging to each of the multiple lines and to allow calculation of Sⱼ/Cⱼ to be carried out in postprocessing.

For example, by using the numbers indicated in FIG. 9B the output generated for the single row 1026 shown in FIG. 9B may be either the six numbers S₁, C₁, S₂, C₂, S₃, C₃:
S₁, C₁, S₂, C₂, S₃, C₃: 34, 11, 111, 11, 188, 11
or the image positions S₁/C₁, S₂/C₂, S₃/C₃ calculated therefrom:
S₁/C₁, S₂/C₂, S₃/C₃: 3.09, 10.09, 17.09.

In this manner the speed of scanning an object can be further increased leading to an improved pickup time of the depth map to be generated.

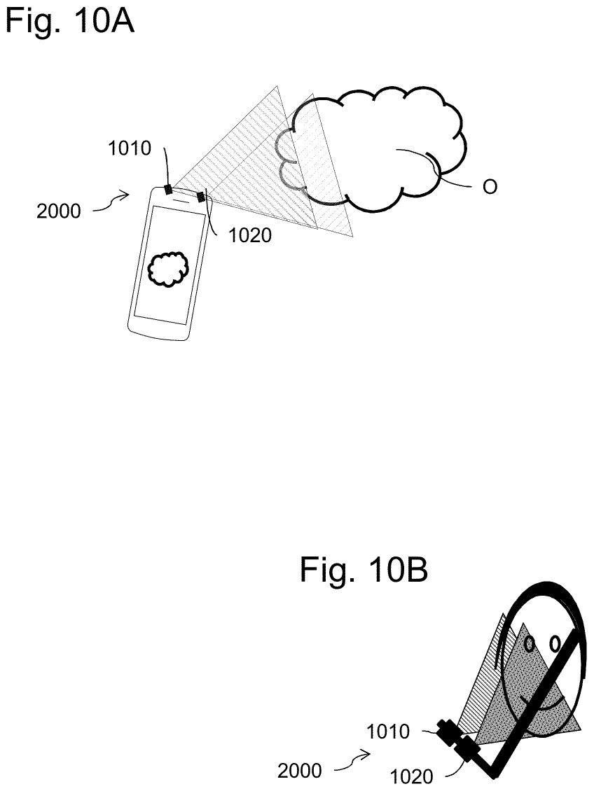

FIGS. 10A and 10B show schematically camera devices 2000 that comprise the depth sensor device 1000 described above. Here, the camera device 2000 is configured to generate a depth map of a captured scene based on the positions of the image I of the illumination pattern obtained for each of the different time periods, i.e. for each of the differing illumination of the object O.

FIG. 10A shows a smart phone that is used to obtain a depth image of an object O. This might be used to improve augmented reality functions of the smart phone or to enhance game experiences available on the smart phone. FIG. 10B shows a face capture sensor that might be used e.g. for face recognition at airports or boarder control, for viewpoint correction or artificial makeup in web meetings, or to animate chat avatars for web meeting or gaming. Further, movie/animation creators might use such an EVS-enhanced face capture sensor to adapt animated figures to real live persons.

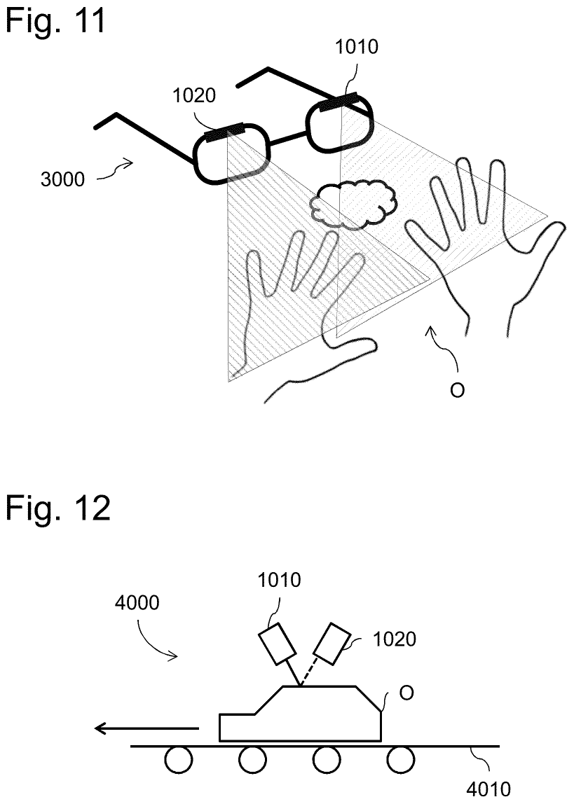

FIG. 11 shows as further example a head mounted display 3000 that comprises a depth sensor device 1000 as described above, wherein the head mounted display 3000 is configured to generate a depth map of an object O viewed through the head mounted display 3000 based on the position of the image I of the illumination pattern obtained for each of the different time periods, i.e. for each of the differing illumination of the object O. This example might be used for accurate hand tracking in augmented reality or virtual reality applications, e.g. in aiding complicated medical tasks.

FIG. 12 shows schematically an industrial production device 4000 that comprises a depth sensor device 1000 as described above, wherein the industrial production device 4000 comprises means 4010 to move objects O in front of the projector unit 1010 in order to achieve the projection of the illumination pattern onto different locations of the objects O, and the industrial production device 4000 is configured to generate depth maps of the objects O based on the positions of the image I of the illumination pattern obtained for each of the different time periods, i.e. for each of the differing illumination of the object O. In this example it is the object O that moves in front of the projector unit 1010. However, since the cause of the relative movement of illumination pattern and object is arbitrary, also in this case a meaningful depth map can be generated. This application is particularly adapted to EVS-enhanced depth sensors, since conveyor belts constituting e.g. the means 4010 to move objects O have a high movement speed that allows depth map generation only if the receiver unit 1020 has a sufficiently high time resolution. Since this is the case for the EVS-enhanced depth sensor devices 1000 described above accurate and high speed depth maps of industrially produced objects O can be obtained that allows fully automated, accurate, and fast quality control of the produced objects O.

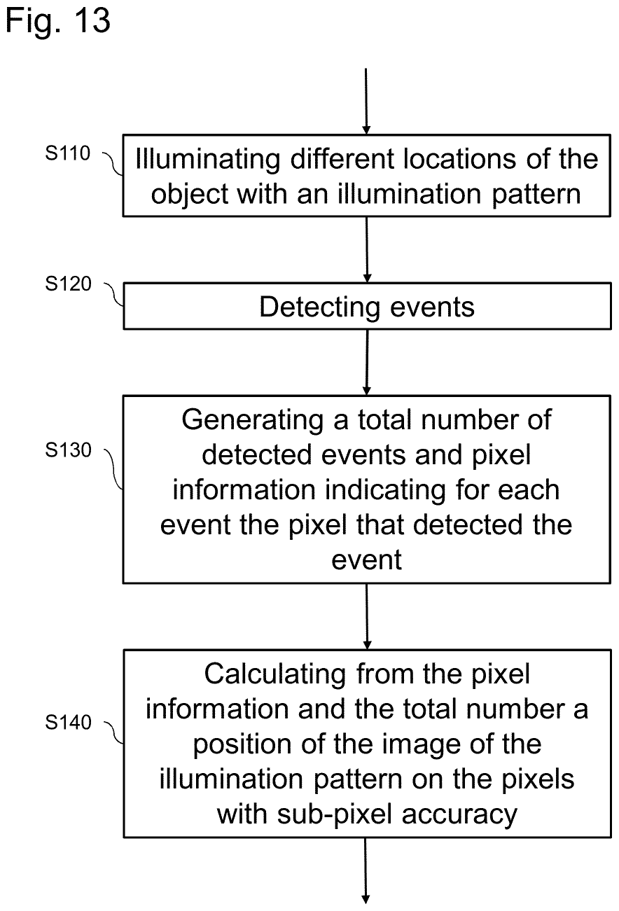

FIG. 13 summarizes the steps of the method for measuring a depth map of an object O with a depth sensor device 1000 described above. The method comprises: At S110, illuminating with the projector unit 1010 different locations of the object O during different time periods with an illumination pattern. At S120, detecting with the receiver unit 1020 on each pixel 1025 intensities of light reflected from the object O while it is illuminated with the illumination pattern, and generating an event at one of the pixels 1025 if the intensity detected at the pixel 1025 changes by more than a predetermined threshold. At S130, generating with the control unit 1030 for each of the different time periods a total number of detected events, and pixel information indicating for each event the pixel 1025 that detected the event. And at S140, calculating with the control unit 1030, from the pixel information and the total number, a position of the image of the illumination pattern on the pixels 1025 with sub-pixel accuracy.

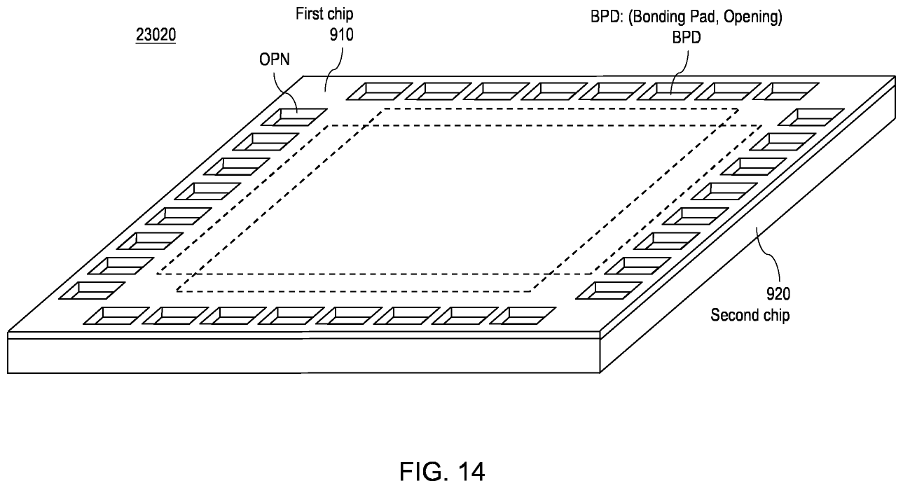

FIG. 14 is a perspective view showing an example of a laminated structure of a solid-state imaging device 23020 with a plurality of pixels arranged matrix-like in array form in which the functions described above may be implemented. Each pixel includes at least one photoelectric conversion element.

The solid-state imaging device 23020 has the laminated structure of a first chip (upper chip) 910 and a second chip (lower chip) 920.

The laminated first and second chips 910, 920 may be electrically connected to each other through TC(S)Vs (Through Contact (Silicon) Vias) formed in the first chip 910.

The solid-state imaging device 23020 may be formed to have the laminated structure in such a manner that the first and second chips 910 and 920 are bonded together at wafer level and cut out by dicing.

In the laminated structure of the upper and lower two chips, the first chip 910 may be an analog chip (sensor chip) including at least one analog component of each pixel, e.g., the photoelectric conversion elements arranged in array form. For example, the first chip 910 may include only the photoelectric conversion elements.

Alternatively, the first chip 910 may include further elements of each photoreceptor module. For example, the first chip 910 may include, in addition to the photoelectric conversion elements, at least some or all of the n-channel MOSFETs of the photoreceptor modules. Alternatively, the first chip 910 may include each element of the photoreceptor modules.

The first chip 910 may also include parts of the pixel back-ends 300. For example, the first chip 910 may include the memory capacitors, or, in addition to the memory capacitors sample/hold circuits and/or buffer circuits electrically connected between the memory capacitors and the event-detecting comparator circuits. Alternatively, the first chip 910 may include the complete pixel back-ends. With reference to FIG. 13A, the first chip 910 may also include at least portions of the readout circuit 140, the threshold generation circuit 130 and/or the controller 120 or the entire control unit.

The second chip 920 may be mainly a logic chip (digital chip) that includes the elements complementing the circuits on the first chip 910 to the solid-state imaging device 23020. The second chip 920 may also include analog circuits, for example circuits that quantize analog signals transferred from the first chip 910 through the TCVs.

The second chip 920 may have one or more bonding pads BPD and the first chip 910 may have openings OPN for use in wire-bonding to the second chip 920.

The solid-state imaging device 23020 with the laminated structure of the two chips 910, 920 may have the following characteristic configuration:

The electrical connection between the first chip 910 and the second chip 920 is performed through, for example, the TCVs. The TCVs may be arranged at chip ends or between a pad region and a circuit region. The TCVs for transmitting control signals and supplying power may be mainly concentrated at, for example, the four corners of the solid-state imaging device 23020, by which a signal wiring area of the first chip 910 can be reduced.

Typically, the first chip 910 includes a p-type substrate and formation of p-channel MOSFETs typically implies the formation of n-doped wells separating the p-type source and drain regions of the p-channel MOSFETs from each other and from further p-type regions. Avoiding the formation of p-channel MOSFETs may therefore simplify the manufacturing process of the first chip 910.

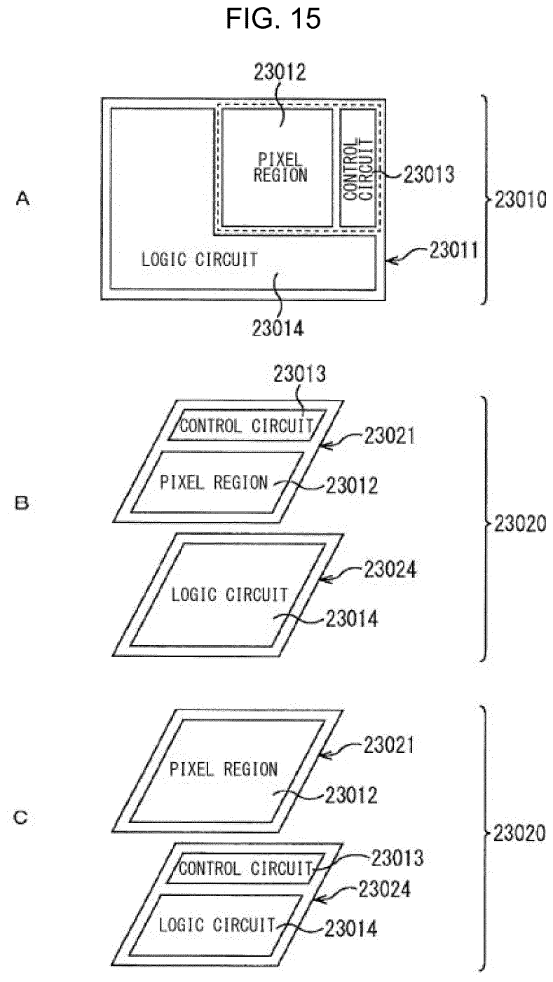

FIG. 15 illustrates schematic configuration examples of solid-state imaging devices 23010, 23020.

The single-layer solid-state imaging device 23010 illustrated in part A of FIG. 15 includes a single die (semiconductor substrate) 23011. Mounted and/or formed on the single die 23011 are a pixel region 23012 (photoelectric conversion elements), a control circuit 23013 (readout circuit, threshold generation circuit, controller, control unit), and a logic circuit 23014 (pixel back-end). In the pixel region 23012, pixels are disposed in an array form. The control circuit 23013 performs various kinds of control including control of driving the pixels. The logic circuit 23014 performs signal processing.

Parts B and C of FIG. 15 illustrate schematic configuration examples of multi-layer solid-state imaging devices 23020 with laminated structure. As illustrated in parts B and C of FIG. 15, two dies (chips), namely a sensor die 23021 (first chip) and a logic die 23024 (second chip), are stacked in a solid-state imaging device 23020. These dies are electrically connected to form a single semiconductor chip.

With reference to part B of FIG. 15, the pixel region 23012 and the control circuit 23013 are formed or mounted on the sensor die 23021, and the logic circuit 23014 is formed or mounted on the logic die 23024. The logic circuit 23014 may include at least parts of the pixel back-ends. The pixel region 23012 includes at least the photoelectric conversion elements.

With reference to part C of FIG. 15, the pixel region 23012 is formed or mounted on the sensor die 23021, whereas the control circuit 23013 and the logic circuit 23014 are formed or mounted on the logic die 23024.

According to another example (not illustrated), the pixel region 23012 and the logic circuit 23014, or the pixel region 23012 and parts of the logic circuit 23014 may be formed or mounted on the sensor die 23021, and the control circuit 23013 is formed or mounted on the logic die 23024.

Within a solid-state imaging device with a plurality of photoreceptor modules PR, all photoreceptor modules PR may operate in the same mode. Alternatively, a first subset of the photoreceptor modules PR may operate in a mode with low SNR and high temporal resolution and a second, complementary subset of the photoreceptor module may operate in a mode with high SNR and low temporal resolution. The control signal may also not be a function of illumination conditions but, e.g., of user settings.

### <Application Example to Mobile Body>

The technology according to the present disclosure may be realized, e.g., as a device mounted in a mobile body of any type such as automobile, electric vehicle, hybrid electric vehicle, motorcycle, bicycle, personal mobility, airplane, drone, ship, or robot.

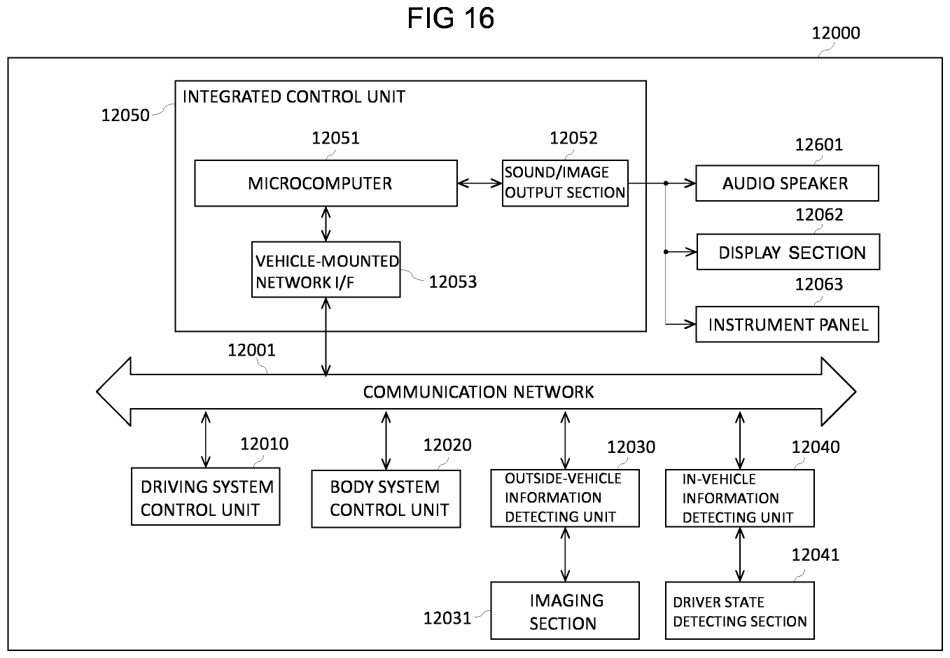

FIG. 16 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 16, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 imaging an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 may be or may include a solid-state imaging sensor with event detection and photoreceptor modules according to the present disclosure. The imaging section 12031 may output the electric signal as position information identifying pixels having detected an event. The light received by the imaging section 12031 may be visible light, or may be invisible light such as infrared rays or the like.

The in-vehicle information detecting unit 12040 detects information about the inside of the vehicle and may be or may include a solid-state imaging sensor with event detection and photoreceptor modules according to the present disclosure. The in-vehicle information detecting unit 12040 is, for example, connected with a driver state detecting section 12041 that detects the state of a driver. The driver state detecting section 12041, for example, includes a camera focused on the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automatic driving, which makes the vehicle to travel autonomously without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound or an image to an output device capable of visually or audible notifying information to an occupant of the vehicle or the outside of the vehicle. In the example of FIG. 16, an audio speaker 12061, a display section 12062, and an instrument panel 12063 are illustrated as the output device. The display section 12062 may, for example, include at least one of an on-board display or a head-up display.

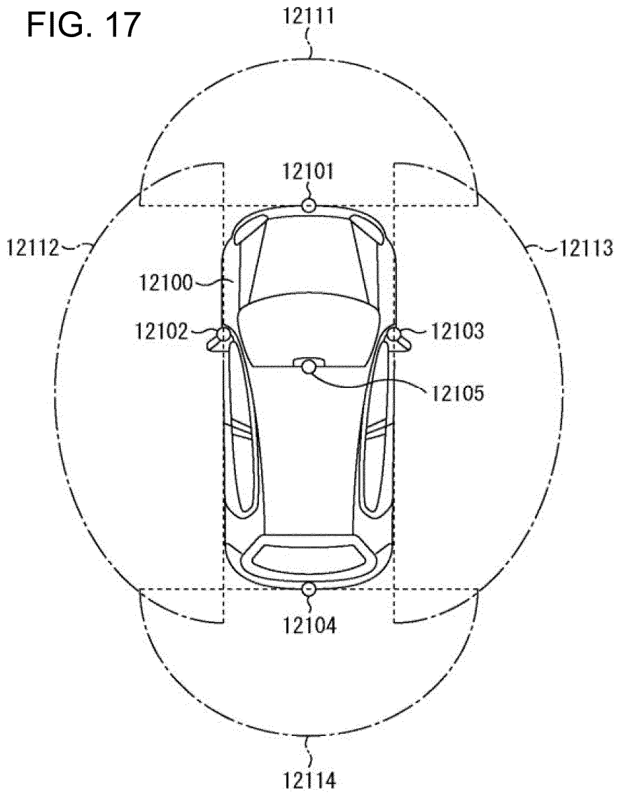

FIG. 17 is a diagram depicting an example of the installation position of the imaging section 12031, wherein the imaging section 12031 may include imaging sections 12101, 12102, 12103, 12104, and 12105.

The imaging sections 12101, 12102, 12103, 12104, and 12105 are, for example, disposed at positions on a front nose, side-view mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the side view mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 17 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the side view mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automatic driving that makes the vehicle travel autonomously without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

The example of the vehicle control system to which the technology according to the present disclosure is applicable has been described above. By applying the photoreceptor modules for obtaining event-triggered image information, the image data transmitted through the communication network may be reduced and it may be possible to reduce power consumption without adversely affecting driving support.

Additionally, embodiments of the present technology are not limited to the above-described embodiments, but various changes can be made within the scope of the present technology without departing from the gist of the present technology.

The solid-state imaging device according to the present disclosure may be any device used for analyzing and/or processing radiation such as visible light, infrared light, ultraviolet light, and X-rays. For example, the solid-state imaging device may be any electronic device in the field of traffic, the field of home appliances, the field of medical and healthcare, the field of security, the field of beauty, the field of sports, the field of agriculture, the field of image reproduction or the like.

Specifically, in the field of image reproduction, the solid-state imaging device may be a device for capturing an image to be provided for appreciation, such as a digital camera, a smart phone, or a mobile phone device having a camera function. In the field of traffic, for example, the solid-state imaging device may be integrated in an in-vehicle sensor that captures the front, rear, peripheries, an interior of the vehicle, etc. for safe driving such as automatic stop, recognition of a state of a driver, or the like, in a monitoring camera that monitors traveling vehicles and roads, or in a distance measuring sensor that measures a distance between vehicles or the like.

In the field of home appliances, the solid-state imaging device may be integrated in any type of sensor that can be used in devices provided for home appliances such as TV receivers, refrigerators, and air conditioners to capture gestures of users and perform device operations according to the gestures. Accordingly the solid-state imaging device may be integrated in home appliances such as TV receivers, refrigerators, and air conditioners and/or in devices controlling the home appliances. Furthermore, in the field of medical and healthcare, the solid-state imaging device may be integrated in any type of sensor, e.g. a solid-state image device, provided for use in medical and healthcare, such as an endoscope or a device that performs angiography by receiving infrared light.

In the field of security, the solid-state imaging device can be integrated in a device provided for use in security, such as a monitoring camera for crime prevention or a camera for person authentication use. Furthermore, in the field of beauty, the solid-state imaging device can be used in a device provided for use in beauty, such as a skin measuring instrument that captures skin or a microscope that captures a probe. In the field of sports, the solid-state imaging device can be integrated in a device provided for use in sports, such as an action camera or a wearable camera for sport use or the like. Furthermore, in the field of agriculture, the solid-state imaging device can be used in a device provided for use in agriculture, such as a camera for monitoring the condition of fields and crops.

The present technology can also be configured as described below:
(1) A depth sensor device for measuring a depth map of an object, the depth sensor device comprising:
   a projector unit configured to illuminate different locations of the object during different time periods with an illumination pattern;
   a receiver unit comprising a plurality of pixels, the receiver unit being configured to detect on each pixel intensities of light reflected from the object while it is illuminated with the illumination pattern, and to generate an event at one of the pixels if the intensity detected at the pixel changes by more than a predetermined threshold; and
   a control unit configured to generate for each of the different time periods a total number of detected events and pixel information indicating for each event the pixel that detected the event, and to calculate from the pixel information and the total number a position of the image of the illumination pattern on the pixels with sub-pixel accuracy.
(2) The depth sensor device according (1), wherein
   each pixel has a response characteristic according to which an instantaneous change of the received intensity to be detected to a given intensity value leads to a gradual change of the detected intensity over time until the detected intensity amounts to the given intensity value.
(3) The depth sensor device according to any one of (1) or (2), wherein
   the projector unit is configured to illuminate the object with a line;
   the plurality of pixels are arranged in a two-dimensional array ordered in rows and columns, assigning to each pixel a row number and a column number;
   the control unit is configured to treat the pixel information for each row separately and for each row the pixel information indicates the column numbers of the pixels in the row; and
   the control unit is configured to calculate for each row a sum of the column numbers of the pixels that detected events, and to calculate the position of the image of the line on the respective row by dividing this sum by the total numbers of events detected in the respective row.
(4) The depth sensor device according to any one of (1) or (2), wherein
   the projector unit is configured to illuminate the object with multiple lines;
   the plurality of pixels are arranged in a two-dimensional array ordered in rows and columns, assigning to each pixel a row number and a column number;
   the control unit is configured to treat the pixel information for each row separately and for each row the pixel information indicates the column numbers of the pixels in the row; and
   the control unit is configured to calculate for each row a plurality of sums of the column numbers of the pixels that detected events, where the number of sums equals the number of projected lines, and to calculate the positions of the images of the lines on the respective row by dividing these sums by the numbers of events detected in the respective row that were assigned to the respective sum.
(5) The depth sensor device according to any one of (3) or (4), wherein
   for each of the different time periods the control unit is configured to consecutively scan all columns in the pixel array a plurality of times, to detect during a scan of one column all pixels in the column that detected an event since the last scan, to add the column number of those pixels to the sum of column numbers for each row of said column containing one of those pixels, and to increase a counter for the total number of events by one for each detected event;
   the sum of column numbers is for each row formed from the column numbers obtained during the plurality of times of scanning and the counter counts each event detected during the plurality of times of scanning until a next one of the different time periods starts;
   the control unit is configured to calculate the position of the image of the line from the sum of column numbers and the counted total number of events obtained until the next one of the different time periods starts.
(6) The depth sensor device according to (5), wherein
   the control unit comprises a memory unit that is configured to store consecutively for each of the different time periods the position of the image of the line in each row; and
   the control unit is configured to output consecutively for each of the different time periods a column vector containing the position of the image of the line in each row with sub-pixel accuracy.
(7) The depth sensor device according to (6), further comprising
   a depth map calculation unit that is configured to calculate from the column vectors obtained for each of the different time periods a depth map of the object.
(8) The depth sensor device according to any one of (3) to (7), wherein
   the control unit is configured to calculate for each row an intermediate sum of the column numbers of the first k pixels that detected events, and to calculate an approximated position of the image of the line on the respective row by dividing this intermediate sum by k, where k is a predetermined natural number; and
   the control unit is configured to reject events of pixels in each of the rows that are located more than an outlier rejection threshold away from the approximated position calculated for the respective row.
(9) The depth sensor device according to (8), wherein
   the control unit is configured to adjust the approximated position and the outlier rejection threshold based on the events detected after the first k detected events.
(10) The depth sensor device according to any one of (1) to (9), wherein
   the control unit comprises hardware components that are configured to generate the total number of detected events and the pixel information and software components that are configured to calculate the position of the image of the illumination pattern.
(11) A camera device comprising the depth sensor device according to any one of (1) to (10), wherein
   the camera device is configured to generate a depth map of a captured scene based on the positions of the image of the illumination pattern obtained for each of the different time periods.
(12) A head mounted display comprising the depth sensor device according to any one of (1) to (10) or the camera device according to (11), wherein
   the had mounted display is configured to generate a depth map of an objected viewed through the head mounted display based on the position of the image of the illumination pattern obtained for each of the different time periods.
(13) An industrial production device comprising the depth sensor device according to (1) to (10) or the camera device according to (11), wherein
   the industrial production device comprises means to move objects in front of the projector in order to achieve the projection of the illumination pattern onto different locations of the objects; and
   the industrial production device is configured to generate depth maps of the objects based on the positions of the image of the illumination pattern obtained for each of the different time periods.
(14) A method for measuring a depth map of an object with a depth sensor device according to any one of (1) to (10), the method comprising:
   illuminating with the projector unit different locations of the object during different time periods with an illumination pattern;
   detecting with the receiver unit on each pixel intensities of light reflected from the object while it is illuminated with the illumination pattern, and generating an event at one of the pixels if the intensity detected at the pixel changes by more than a predetermined threshold;
   generating with the control unit for each of the different time periods a total number of detected events and pixel information indicating for each event the pixel that detected the event; and
   calculating with the control unit from the pixel information and the total number a position of the image of the illumination pattern on the pixels with sub-pixel accuracy.

1. A depth sensor device for measuring a depth map of an object, the depth sensor device comprising:
a projector unit configured to illuminate different locations of the object during different time periods with an illumination pattern;
a receiver unit comprising a plurality of pixels, the receiver unit being configured to detect on each pixel intensities of light reflected from the object while it is illuminated with the illumination pattern, and to generate an event at one of the pixels if the intensity detected at the pixel changes by more than a predetermined threshold; and
a control unit configured to generate for each of the different time periods a total number of detected events and pixel information indicating for each event the pixel that detected the event, and to calculate from the pixel information and the total number a position of the image of the illumination pattern on the pixels with sub-pixel accuracy.

2. The depth sensor device according to claim 1, wherein
each pixel has a response characteristic according to which an instantaneous change of the received intensity to be detected to a given intensity value leads to a gradual change of the detected intensity over time until the detected intensity amounts to the given intensity value.

3. The depth sensor device according to claim 1, wherein
the projector unit is configured to illuminate the object with a line;
the plurality of pixels are arranged in a two-dimensional array ordered in rows and columns, assigning to each pixel a row number and a column number;
the control unit is configured to treat the pixel information for each row separately and for each row the pixel information indicates the column numbers of the pixels in the row; and
the control unit is configured to calculate for each row a weighted sum of the column numbers of the pixels that detected events, and to calculate the position of the image of the line on the respective row by dividing this sum by the total numbers of events detected in the respective row.

4. The depth sensor device according to claim 1, wherein
the projector unit is configured to illuminate the object with multiple lines;
the plurality of pixels are arranged in a two-dimensional array ordered in rows and columns, assigning to each pixel a row number and a column number;
the control unit is configured to treat the pixel information for each row separately and for each row the pixel information indicates the column numbers of the pixels in the row; and
the control unit is configured to calculate for each row a plurality of sums of the column numbers of the pixels that detected events, where the number of sums equals the number of projected lines, and to calculate the positions of the images of the lines on the respective row by dividing these sums by the numbers of events detected in the respective row that were assigned to the respective sum.

5. The depth sensor device according to claim 3, wherein
for each of the different time periods the control unit is configured to consecutively scan all columns in the pixel array a plurality of times, to detect during a scan of one column all pixels in the column that detected an event since the last scan, to add the column number of those pixels to the sum of column numbers for each row of said column containing one of those pixels, and to increase a counter for the total number of events by one for each detected event;
the sum of column numbers is for each row formed from the column numbers obtained during the plurality of times of scanning and the counter counts each event detected during the plurality of times of scanning until a next one of the different time periods starts; and
the control unit is configured to calculate the position of the image of the line from the sum of column numbers and the counted total number of events obtained until the next one of the different time periods starts.

6. The depth sensor device according to claim 5, wherein
the control unit comprises a memory unit that is configured to store consecutively for each of the different time periods the position of the image of the line in each row; and
the control unit is configured to output consecutively for each of the different time periods a column vector containing the position of the image of the line in each row with sub-pixel accuracy.

7. The depth sensor device according to claim 6, further comprising
a depth map calculation unit that is configured to calculate from the column vectors obtained for each of the different time periods a depth map of the object.

8. The depth sensor device according to claim 3, wherein
the control unit is configured to calculate for each row an intermediate sum of the column numbers of the first k pixels that detected events, and to calculate an approximated position of the image of the line on the respective row by dividing this intermediate sum by k, where k is a predetermined natural number; and
the control unit is configured to reject events of pixels in each of the rows that are located more than an outlier rejection threshold away from the approximated position calculated for the respective row.

9. The depth sensor device according to claim 8, wherein
the control unit is configured to adjust the approximated position and the outlier rejection threshold based on the events detected after the first k detected events.

10. The depth sensor device according to claim 1, wherein
the control unit comprises hardware components that are configured to generate the total number of detected events and the pixel information and software components that are configured to calculate the position of the image of the illumination pattern.

11. A camera device comprising the depth sensor device according to claim 1, wherein
the camera device is configured to generate a depth map of a captured scene based on the positions of the image of the illumination pattern obtained for each of the different time periods.

12. A head mounted display comprising the depth sensor device according to claim 1, wherein
the head mounted display is configured to generate a depth map of an object viewed through the head mounted display based on the position of the image of the illumination pattern obtained for each of the different time periods.

13. An industrial production device comprising the depth sensor device according to claim 1, wherein
the industrial production device comprises means to move objects in front of the projector unit in order to achieve the projection of the illumination pattern onto different locations of the objects; and
the industrial production device is configured to generate depth maps of the objects based on the positions of the image of the illumination pattern obtained for each of the different time periods.

14. A method for measuring a depth map of an object with a depth sensor device according to claim 1, the method comprising:
illuminating with the projector unit different locations of the object during different time periods with an illumination pattern;
detecting with the receiver unit on each pixel intensities of light reflected from the object while it is illuminated with the illumination pattern, and generating an event at one of the pixels if the intensity detected at the pixel changes by more than a predetermined threshold;
generating with the control unit for each of the different time periods a total number of detected events and pixel information indicating for each event the pixel that detected the event; and
calculating with the control unit from the pixel information and the total number a position of the image of the illumination pattern on the pixels with sub-pixel accuracy.
